(19) United States
(12) Patent Application Publication
(10) Pub. No.: US 2026/0287056 A1
(43) Pub. Date: Sep. 24, 2026

(54) SWITCHING DEVICE FOR A GEARBOX OF A MOTOR VEHICLE, GEARBOX FOR A MOTOR VEHICLE, AND MOTOR VEHICLE

(71) Applicant: MERCEDES-BENZ GROUP AG, Stuttgart (DE)

(72) Inventor: Tobias HAERTER, Stuttgart (DE)

(21) Appl. No.: 19/478,508

(22) PCT Filed: Mar. 22, 2024
(86) PCT No.: PCT/EP2024/057712

§ 371 Date: Oct. 24, 2025

(30) Foreign Application Priority Data
Apr. 27, 2023 (DE) 10 2023 001 685.3

(51) Int. Cl. F16H 63/30; F16H 48/10; F16H 63/28; F16H 63/34

(52) U.S. Cl. CPC F16H 63/3023; F16H 48/10; F16H 63/28; F16H 63/3416; F16H 2048/104; F16H 2048/106

(57) ABSTRACT

A switching device for a gearbox of a motor vehicle has a double-acting piston-cylinder unit for actuating a first switching unit and a second switching unit. The piston-cylinder unit includes a cylinder and an actuating piston displaceably arranged in the cylinder. A spring device causes displacement of the actuating piston. A locking device can block the spring device to suppress displacement of the actuating piston that can be caused by the spring device. A carrier is connected to the actuating piston of the piston-cylinder unit and protrudes from the cylinder in the radial direction of the actuating piston is provided so that the spring device can displacement the actuating piston so that the first switching unit is moved into an insertion position of the first switching unit.

### BACKGROUND AND SUMMARY OF THE INVENTION

Exemplary embodiments of the invention relate to a switching device for a gearbox of a motor vehicle, also referred to as a motor vehicle gearbox, to a gearbox for a motor vehicle, also referred to as a motor vehicle gearbox, and to a motor vehicle.

A hydraulic controller for an automatic gearbox of a motor vehicle is known from EP 2 609 348 B1, having a parking lock actuating system with a parking lock slide and a parking lock piston-cylinder unit having a parking lock piston and a first parking lock pressure chamber. Furthermore, DE 10 2011 107 263 A1 discloses a hydraulic actuating device to actuate one or more actuators in a motor vehicle gearbox.

DE 10 2019 107 710 A1 also discloses a switching device for a gearbox, wherein a piston of a double-acting piston-cylinder unit can be displaced both hydraulically as well as via a spring device, and wherein a locking device is provided, by means of which the spring device can be blocked to prevent the displacement of the piston that can be caused by means of the spring device.

Exemplary embodiments of the present invention are directed to a switching device for a gearbox of a motor vehicle, a gearbox for a motor vehicle, and a motor vehicle, so that a particularly advantageous switchability can be realized.

A first aspect of the invention relates to a switching device for a gearbox, also referred to as a motor vehicle gearbox, of a motor vehicle which is also simply referred to as a vehicle and in its completely produced state has the gearbox and thus the switching device. More preferably, the motor vehicle is designed as an automobile, in particular as a passenger car. For example, the motor vehicle has at least or exactly two vehicle axles, also simply referred to as axles, arranged successively and thus one behind the other in the vehicle longitudinal direction of the motor vehicle. The respective vehicle axle has at least or exactly two vehicle wheels, also simply referred to as wheels. The vehicle wheels of the respective vehicle axle are arranged on opposite sides of the motor vehicle in the vehicle transverse direction of the motor vehicle. The vehicle wheels are ground contact elements, by which the motor vehicle can be or is supported downwards on ground, in the vehicle vertical direction of the motor vehicle. If the motor vehicle drives along the ground while the motor vehicle is supported downwards on the ground by the ground contact elements in the vehicle vertical direction of the motor vehicle, the vehicle wheels roll, in particular directly, on the ground. For example, the vehicle wheels of at least or exactly one of the vehicle axles can be driven, in particular by means of a drive device of the motor vehicle, whereby the motor vehicle can be driven overall. For example, in the completely produced state of the motor vehicle, the switching device or the gearbox is a component part, in particular specifically, of one of the vehicle axles. When the vehicle wheels or the wheels are referred to above or in the following, if not otherwise stated, these are understood to mean the vehicle wheels of the vehicle axle, which in the completely produced state of the vehicle comprises the switching device and thus the gearbox. The vehicle wheels that can be driven by means of the drive device are also referred to as drive wheels, wherein more preferably it is provided that the drive wheels are the vehicle wheels.

The switching device has a double-acting piston-cylinder unit for actuating a first switching unit and a second switching unit. This means that both the first switching unit as well as the second switching unit can be actuated by means of the piston-cylinder unit. More preferably, it is provided that the switching device has the first switching unit and the second switching unit. The piston-cylinder unit, which is also simply referred to as an actuating unit, has a cylinder designed in particular as a fixed body and an actuating piston displaceably arranged in the cylinder, which piston thus can be displaced, i.e. in a reciprocating manner, along a movement direction relative to the cylinder. The cylinder of the piston-cylinder unit is thus understood to mean a housing designed as a fixed body, which delimits, in particular directly, a working space, in particular in that the working space is delimited, in particular directly, by an inner circumferential lateral surface of the cylinder. In this case, the actuating piston is displaceably arranged in the working space, i.e., such that it can be displaced relative to the cylinder in particular along the movement direction. More particularly, the working space or the inner circumferential lateral surface is cylindrical. In particular, the feature that the piston-cylinder unit is double-acting can be understood to mean that the actuating piston can be displaced relative to the cylinder in a first direction, running parallel to the movement direction or coinciding with the movement direction, and in a second direction, coinciding with the movement direction or running parallel to the movement direction, opposing the first direction.

Due to the displacement of the actuating piston in the first direction, occurring relative to the cylinder, for example, the first switching unit and preferably also the second switching unit can be actuated, in particular in such a way that the first switching unit is engaged and, for example, the second switching unit is, in particular simultaneously, disengaged. Due to the displacement of the actuating piston in the second direction, occurring relative to the cylinder, for example, the second switching unit and preferably also the first switching unit can be actuated, in particular in such a way that the second switching unit is engaged and the first switching unit is preferably, in particular simultaneously, disengaged.

In other words, for example, due to the displacement of the actuating piston occurring relative to the cylinder and in the first direction, the first switching unit can be engaged and preferably, in particular simultaneously, the second switching unit can be disengaged. For example, due to the displacement of the actuating piston occurring relative to the cylinder and in the second direction, the second switching unit can also be engaged and, in particular simultaneously, the first switching unit can be disengaged. Due to the engaging of the first switching unit, for example, a first gear of the gearbox can be engaged and, for example, due to the disengaging of the second switching unit, for example, a second gear of the gearbox can be disengaged. Due to the engaging of the second switching unit, for example, the second gear can be engaged, and due to the disengaging of the first switching unit, for example, the first gear can be disengaged. For example, the first switching unit can be displaced, in particular relative to the cylinder, between at least one first engaged position and at least one first disengaged position. In the first engaged position, the first switching unit is engaged, and in the first disengaged position, the first switching unit is disengaged. In particular, for example, due to the displacement of the actuating piston occurring relative to the cylinder and in the first direction, the first switching unit can be moved, in particular displaced, into the first engaged position, in particular from the first disengaged position. For example, due to the displacement of the actuating piston occurring relative to the cylinder and in the first direction, the second switching unit can be moved, in particular displaced, into the second disengaged position, in particular from the second engaged position. For example, due to the displacement of the actuating piston occurring relative to the cylinder and in the second direction, the second switching unit can be moved, in particular displaced, into the second engaged position, in particular from the second disengaged position. For example, due to the displacement of the actuating piston occurring relative to the cylinder and in the second direction, the first switching unit can be moved, in particular displaced, into the first disengaged position, in particular from the first engaged position. Thus, for example, the movement, in particular displacement, of the first switching unit from the first disengaged position into the first engaged position, in particular simultaneously, accompanies the movement, in particular displacement, of the second switching unit from the second engaged position into the second disengaged position. Furthermore, for example, the movement, in particular displacement, of the second switching unit from the second disengaged position into the second engaged position, in particular simultaneously, accompanies the movement, in particular displacement, of the first switching unit from the first engaged position into the first disengaged position.

The respective movement, in particular displacement, of the respective switching unit is also referred to as actuating or actuation of the respective switching unit, so that it can be seen that both the first switching unit as well as the second switching unit can be actuated by means of the piston-cylinder unit.

The switching device furthermore has a spring device, provided in particular in addition to the piston-cylinder unit, to cause displacement of the actuating piston. Preferably, the spring device is an external component in relation to the piston-cylinder unit, i.e. is arranged externally in relation to the piston-cylinder unit, and preferably the piston-cylinder unit is an external component in relation to the spring device, i.e., is arranged externally in relation to the spring device.

For example, the actuating piston, in particular a first actuating surface of the actuating piston, can be loaded, in particular directly, with an actuating fluid, in the form for example of a hydraulic fluid, i.e., hydraulic liquid. It is also conceivable that the actuating piston, in particular a second actuating surface of the actuating piston, can be loaded, in particular directly, with the actuating fluid. In this case, the second actuating surface is facing away from the first actuating surface in the axial direction of the actuating piston, the radial direction of which runs perpendicular to the axial direction of the actuating piston, and the first actuating surface is facing away from the second actuating surface in the axial direction of the actuating piston.

“Axial direction of the actuating piston” is understood to mean the direction of an axis of rotational symmetry of the cylinder. The cylinder has a cylindrical shape which is arranged coaxially to the axis of rotational symmetry. The axial direction of the actuating piston is identical to the movement direction of the actuating piston.

Due to the loading of the first actuating surface with the actuating fluid, the actuating piston can be displaced relative to the cylinder in the first direction, and due to the loading of the second actuating surface with the actuating fluid, the actuating piston can be displaced in the second direction relative to the cylinder. For example, the respective actuating surface runs in a respective plane, which preferably runs perpendicular to the axial direction of the actuating piston and thus perpendicular to the movement direction of the actuating piston. For example, the aforementioned working space is divided by means of the actuating piston into two working chambers which, for example, are arranged on sides of the actuating piston facing away from each other in the axial direction of the actuating piston. For example, a first of the working chambers is partially and preferably directly delimited by the first actuating surface, and, for example, a second of the working chambers is partially and preferably directly delimited by the second actuating surface. More preferably, the actuating fluid is a liquid which is also referred to as a hydraulic liquid. Thus, the actuating piston and, via the actuating piston, the switching units can be actuated preferably hydraulically.

For example, the spring device can cause the mentioned displacement of the actuating piston, in particular purely, mechanically. For this purpose, for example, the spring device has at least or exactly one spring element, which is preferably designed as a fixed body and thus as a mechanical spring. The spring element can provide a spring force, by means of which the displacement of the actuating piston can be caused i.e. the actuating piston can be displaced. For example, the actuating piston can be displaced relative to the cylinder, in particular along the movement direction, between at least one first actuating position and at least one second actuating position. Due to the displacement of the actuating piston, in particular from the second actuating position, into the first actuating position, the first switching unit, for example, can be actuated, in particular in such a way that the first switching unit can be engaged, i.e. can be moved, in particular displaced, into the first engaged position. Due to the displacement of the actuating piston, in particular from the first actuating position, into the second actuating position, the second switching unit, for example, can be actuated, in particular in such a way that the second switching unit can be engaged, i.e. can be moved, in particular displaced, in particular into the second engaged position. Thus, for example, due to the displacement of the actuating piston, in particular from the second actuating position, into the first actuating position, the first switching unit can be disengaged and, in particular simultaneously, the second switching unit can be disengaged. Furthermore, for example, due to the displacement of the actuating piston, in particular from the first actuating position, into the second actuating position, the second switching unit can be engaged and, in particular simultaneously, the first switching unit can be disengaged.

In particular, it is conceivable that the switching units can be connected to each other in terms of movement and thus can be moved, in particular displaced, together, i.e. simultaneously, so that, for example, the movement, in particular displacement, of the first switching unit from the first disengaged position into the first engaged position, in particular simultaneously, accompanies the movement, in particular displacement, of the second switching unit from the second engaged position into the second disengaged position, and so that, for example, the movement, in particular displacement, of the second switching unit from the second disengaged position into the second engaged position, in particular simultaneously, accompanies the movement, in particular displacement, of the first switching unit from the first engaged position into the first disengaged position.

Furthermore, it is conceivable that the respective switching unit can be moved, in particular displaced, into a respective neutral position, in particular relative to the cylinder. In the neutral position of the first switching unit, the first switching unit is disengaged, so that, for example, the first gear is disengaged. In the neutral position of the second switching unit, the second switching unit is disengaged, so that, for example, the second gear is disengaged. As, for example, the switching units can be moved together, in particular between the engaged positions and the disengaged positions, the switching units, for example, can be moved together into the neutral position, so that, for example, when and in particular whenever, the first switching unit is located in the neutral position of the first switching unit, the second switching unit is also located in the neutral position of the second switching unit. For example, the actuating piston can be displaced relative to the cylinder and in particular along the movement direction into a deactivation position, also referred to as an intermediate position or in the form of an intermediate position, wherein, for example, the deactivation position lies between the first actuating position and the second actuating position, in particular when viewed along the movement direction. For example, the actuating piston can be displaced from the first actuating position into the second direction relative to the cylinder and therefore can be displaced into the deactivation position, and, for example, the actuating piston can be displaced relative to the cylinder in the first direction and therefore can be displaced from the second actuating position into the deactivation position. Due to the displacement of the actuating piston into the deactivation position, the switching units can be or are moved, in particular can be or are displaced, in particular simultaneously, into the neutral position of the switching units. Thus, for example, both switching units are, in particular simultaneously, disengaged in the and due to the deactivation position of the actuating piston, i.e., for example, both gears are, in particular simultaneously, disengaged.

In particular, it is conceivable that due to the displacement of the actuating piston, occurring relative to the cylinder and in the second direction, the spring element is to be tensioned or is tensioned, so that, for example, the spring element provides the mentioned spring force at least in the second actuating position of the actuating piston, which spring force acts, for example, at least indirectly on the actuating piston located in particular in the second actuating position. Thus, for example, the actuating piston can be displaced relative to the cylinder in the first direction by means of the spring force, i.e. by means of the spring element, and therefore, for example, can be displaced, in particular from the second actuating position, into the first actuating position.

When the displacement of the actuating piston is referred to above and in the following, unless otherwise stated, this is understood to mean the displacement of the actuating piston caused by means of the spring device.

The switching device further has a locking device, which is preferably external in relation to the spring device and in relation to the piston-cylinder unit, wherein preferably the spring device and the piston-cylinder unit are each external in relation to the locking device. The spring device can be blocked by means of the locking device, whereby the displacement of the actuating piston that can be caused by means of the spring device in particular in the first direction, can be omitted, i.e. avoided. In other words, the spring device can exert a displacement effect, in particular on the actuating piston, in order thereby to displace the actuating piston relative to the cylinder in particular in a movement direction. The displacement effect can be blocked by means of the locking device so that, for example, the actuating piston cannot be displaced by means of the spring device when the spring device is blocked by means of the locking device and thus the displacement of the actuating piston that can be caused by means of the spring device is omitted, in particular even when the spring element is tensioned and thus provides the spring force.

As the actuating piston, for example, can be actuated, i.e. displaced, both by means of the actuating fluid and thus in particular hydraulically as well as by means of the spring device, redundant actuation of the actuating piston is provided, whereby particularly high switching security can be realized.

In order to be able to realize particularly advantageous switching, according to the invention a carrier is provided that is connected to the actuating piston of the piston-cylinder unit and thus can be moved, i.e., displaced, with actuating piston relative to the cylinder in particular along the movement direction. For example, the carrier is designed separately from the actuating piston and is connected to the actuating piston, in particular in such a way that relative movements between the carrier and the actuating piston are omitted. Furthermore, it is conceivable that the actuating piston and the carrier are designed as one piece together, i.e. are formed from a single piece. In particular, this means that the actuating piston and the carrier are not composed of two parts designed separately from each other and connected to each other, i.e. that the actuating piston and the carrier are not designed separately from each other and connected to each other, but rather preferably the actuating piston and the carrier are formed by a one-piece element, i.e., from an element formed from a single piece, which thus is designed as a one-piece monobloc, i.e., a monobloc formed from a single piece and thus produced integrally.

The carrier protrudes from the cylinder in the radial direction of the actuating piston and thus in the radial direction of the cylinder, i.e., along a direction running perpendicular to the movement direction, so that, for example, at least one partial region of the carrier is arranged in the surroundings of the cylinder. The displacement of the actuating piston that can be caused by means of the spring device can be caused by means of the spring device via the carrier, whereby the first switching unit can be moved, in particular displaced, into the first engaged position of the first switching unit via the actuating piston. In other words, the spring device can in particular displace the carrier and via the carrier the actuating piston relative to the cylinder in the first direction when the locking device does not block but releases the displacement effect of the spring device, whereby the actuating piston can be displaced into the first actuating position and thus the first switching unit can be moved into the first engaged position of the first switching unit via the actuating piston.

This means that a space-efficient and cost-effective actuation and thus switching of the first switching unit can be achieved. In other words, it is provided according to the invention that the spring device is designed to act on the carrier and therefore, i.e., via the carrier, to displace the actuating piston relative to the cylinder into the first actuating position, whereby the first switching unit can be moved, in particular displaced, into the first engaged position of the first switching unit via the actuating piston. In particular, the carrier is connected fixed to the actuating piston, in particular in such a way that relative movements between the carrier and the actuating piston are omitted. In particular, the invention makes it possible to move the actuating piston by means of the spring device and thus mechanically into the first actuating position and thus, via the actuating piston, to mechanically move the first switching unit into the first engaged position in a space-efficient and weight-optimized and cost-effective manner when the actuating piston cannot be loaded with the actuating fluid or when the actuating piston cannot be moved into the first actuating position due to the loading of the actuating piston with the actuating fluid, meaning that the first switching unit cannot be moved into the first engaged position by means of the actuating fluid. The spring device functions as a spring accumulator or is a spring accumulator, wherein the actuating piston and, via the actuating piston, the first switching unit can advantageously be actuated, i.e. moved, by means of the spring accumulator securely, cost-effectively and in a space-optimized and weight-optimized manner.

In order to be able to realize a particularly simple and thus cost-effective construction and thus to ensure particularly advantageous switching, it is provided in one embodiment of the invention that the spring device is arranged radially, i.e., in the radial direction of the actuating piston and thus of the cylinder, outside the cylinder.

A further embodiment is characterized in that the spring device has a spring cylinder and a spiral spring arranged at least partially inside the spring cylinder. The spiral spring is thus the aforementioned spring element. The spring cylinder is a second housing, in particular designed as a fixed body, in which the spiral spring is at least partially arranged. Thus, a particularly simple construction of the spring device can be realized, so that a simple and thus robust switching of the switching device can be achieved.

In this case, it has proven particularly advantageous when the spring cylinder is designed in one piece, i.e. integrally, with a cover of the piston-cylinder unit. In particular, this is understood to mean that the spring cylinder and the cover are not designed separately from each other and connected to each other, but rather preferably the spring cylinder and the cover are formed from a single piece and thus are formed by a monobloc, designed in one piece, i.e. formed from a single piece and thus produced integrally.

For example, the cover is designed separately from the cylinder of the piston-cylinder unit and is connected to the cylinder. In particular, it is conceivable that one of the working chambers, in particular the second working chamber, is partially and for example directly delimited by the cover. In this case, for example, the cover has an end face which opposes the second actuating surface in the axial direction of the actuating piston and in particular is facing towards the second actuating surface.

Particularly advantageously, the spring cylinder and the cover of the piston-cylinder unit are designed together as a single cast part.

In order to be able to ensure particularly advantageous and secure switching of the switching device, it is provided in a further embodiment of the invention that the switching device has a shift fork connected to the actuating piston. Thus, for example, the shift fork can be displaced with the actuating piston in particular relative to the cylinder, meaning that, for example, the shift fork can be displaced in a reciprocating manner with the actuating piston between the actuating positions. In this case, it is conceivable that the switching units can be actuated by means of the actuating piston via the shift fork. It is also conceivable that the shift fork comprises the first switching unit or at least one first part of the first switching unit. Alternatively or additionally, the shift fork can comprise the second switching unit or at least one second part of the second switching unit.

Thus, in order to realize particularly advantageous and robust switching, it has proven particularly advantageous when the shift fork can be displaced by the displacement of the actuating piston that can be caused by means of the spring device via the carrier, whereby the first switching unit can be moved, in particular displaced, into the first engaged position via the shift fork. This means in particular that the first switching unit can be moved, in particular can be displaced, into the first engaged position by the displacement of the actuating piston that can be caused by means of the device and thus by the displacement of the shift fork into the first actuating position of the actuating piston, whereby a particularly advantageous, redundant and thus robust switching or switchability of the switching device can be achieved.

A second aspect of the invention relates to a gearbox designed, for example, as an automatic gearbox for a motor vehicle, also simply referred to as a vehicle. The gearbox has a differential gear, which has a differential input shaft. The gearbox furthermore has a gearbox shaft and a parking lock device. Furthermore, the gearbox comprises a switching device according to the first aspect of the invention. Advantages and advantageous embodiments of the first aspect of the invention are to be regarded as advantages and advantageous embodiments of the second aspect of the invention and vice versa.

For example, the differential input shaft can be rotated about a first shaft rotational axis relative to a housing of the gearbox. For example, the gearbox shaft can also be rotated about a second shaft rotational axis relative to the housing. The gearbox shaft and the differential input shaft can be arranged coaxially to each other so that the shaft rotational axes coincide. It is also conceivable that the gearbox shaft and the differential input shaft are arranged axially offset to each other, so that the shaft rotational axes are spaced apart from each other and run parallel to each other.

In this case, it has proven particularly advantageous when the parking lock device is designed to connect the gearbox shaft to the housing of the gearbox for conjoint rotation. For this purpose, the parking lock device can be switched between an engaged state and a disengaged state, for example. The engaged state is also referred to as a P state or as P, for example, and the disengaged state is also referred to as a not-P state or not-P, for example. In the engaged state, the gearbox shaft is connected to the housing by means of the parking lock device for conjoint rotation, so that there are no relative rotations between the gearbox shaft and the housing occurring about the second shaft rotational axis. In the disengaged state, the parking lock device enables relative rotations between the gearbox shaft and the housing, occurring about the second shaft rotational axis. As is well known from the general prior art, in the engaged state of the parking lock device, for example, the parking lock device can prevent the vehicle wheels from rotating relative to the housing, so that, for example, the motor vehicle can in particular then be secured against undesired rolling away when the motor vehicle has stopped on an incline and is parked. In the disengaged state, the parking lock device allows rotations of the vehicle wheels occurring relative to the housing, so that in the disengaged state of the parking lock device, the motor vehicle can roll and thus, for example, can be driven along the aforementioned ground. Therefore, the first switching unit is designed to connect the gearbox shaft to the differential input shaft for conjoint rotation. For example, this is or can be realized in such a way that, for example, in the first engaged position of the first switching unit, the gearbox shaft is connected to the differential input shaft by means of the first switching unit for conjoint rotation, so that there cannot be any relative rotations between the gearbox shaft and the differential input shaft occurring about the respective shaft rotational axis. In the first disengaged position, the first switching unit enables relative rotations between the gearbox shaft and the differential input shaft, occurring about the respective shaft rotational axis. Thus, for example, in order to secure the motor vehicle against undesired rolling away, in particular when it has stopped and is parked on an incline, the parking lock device, for example, is switched into its engaged state while the first switching unit is located in the first engaged state. Therefore, for example, the vehicle wheels are connected to the housing via the gearbox shaft and via the differential input shaft for conjoint rotation, which means that there cannot be any relative rotations between the respective vehicle wheel and the housing.

In an advantageous embodiment of the second aspect of the invention, an electric engine is provided, which has a first rotor to which the gearbox shaft is connected, in particular permanently, for conjoint rotation. For example, the first electric engine can provide first drive torques via its first rotor to drive, in particular purely electrically drive, the motor vehicle, in particular the vehicle wheels. For example, the first electric engine has a first stator, by means of which the first rotor can be driven and therefore can be rotated about a first engine rotational axis relative to the first stator. For example, the first rotor is arranged coaxially to the gearbox shaft and/or differential input shaft so that, for example, the engine rotational axis coincides with the respective shaft rotational axis.

A further embodiment is characterized by a second electric engine, which is provided in addition to the first electric engine and has a second rotor. For example, the second electric engine can provide second drive torques via the second rotor to drive, in particular purely electrically drive, the vehicle wheels and thus the motor vehicle. In particular, the second electric engine can have a second stator, by means of which the second rotor can be driven and therefore can be rotated about a second engine rotational axis relative to the second stator. For example, the electric engines are arranged coaxially to each other, such that the engine rotational axes coincide. For example, the second electric engine can also be arranged coaxially to the gearbox shaft and/or differential input shaft, so that preferably the second engine rotational axis coincides with the respective shaft rotational axis.

The gearbox has a third switching unit which is also referred to as a third switching element. The third switching unit of the gearbox is designed to connect the second rotor to the gearbox shaft for conjoint rotation. For example, the third switching unit can be switched over between a coupled stated and a decoupled state. For example, the third switching unit can be moved, in particular translationally and/or relative to the housing, between at least one third engaged position, causing the coupled state, and at least one third disengaged position, causing the decoupled state. In the coupled state, the second rotor is connected to the gearbox shaft by means of the third switching unit for conjoint rotation. In the decoupled state, the third switching unit allows relative rotations between the second rotor and the gearbox shaft, occurring about the second engine rotational axis or about the second shaft rotational axis. The first electric engine and the second electric engine are arranged axially on different sides of the differential gear. In other words, for example, the first electric engine is arranged on a first side of the differential gear, wherein the second electric engine is arranged on a second side of the differential gear. In this case, the second side of the differential gear is facing away from the first side of the differential gear, when viewed in the axial direction of the differential gear and thus along the first shaft rotational axis, and vice versa. As a result, a particularly compact design can be achieved.

Lastly, it has proven particularly advantageous when the gearbox has a first planetary gear set having a first sun gear, a first planetary carrier and a first ring gear. Furthermore, preferably the gearbox has a second planetary gear set having a second sun gear, a second planetary carrier and a second ring gear. In this case it is preferably provided that the first planetary carrier and the second planetary carrier are connected, in particular permanently, to each other for conjoint rotation and function as or are designed as the differential input shaft. The first ring gear and the second ring gear function as differential output shafts. In other words, for example, the first ring is a first differential output shaft and the second ring gear, for example, is a second differential output shaft. A respective, first input torque can be introduced into the differential gear via the differential input shaft, wherein, for example, the respective, first input torque results from the respective, first drive torque and/or from the respective, second drive torque. Via the respective differential output shaft, the differential gear can provide a respective output torque, which results from the respective input torque. The respective vehicle wheel can be driven by means of the respective output torque. The second switching unit is designed to connect the gearbox shaft to the second sun gear for conjoint rotation. Thus, for example, in the second engaged position of the second switching unit, the gearbox shaft is connected to the second sun gear by means of the second switching unit for conjoint rotation. In the second disengaged position, the second switching unit enables relative rotations between the gearbox shaft and the second sun gear, in particular occurring about the second shaft rotational axis. This means that particularly advantageous switchability or switching can be achieved.

A third aspect of the invention relates to a motor vehicle, also simply referred to as a vehicle, which preferably is designed as a motor car, in particular as a passenger car. The motor vehicle according to the third aspect of the invention has a gearbox according to the second aspect of the invention. Advantages and advantageous embodiments of the first aspect of the invention and of the second aspect of the invention are to be regarded as advantages and advantageous embodiments of the third aspect of the invention and vice versa.

Preferably, the respective electric engine is a high-voltage component, the electric voltage of which, in particular electric operating or rated voltage, is preferably greater than 50 volts, in particular greater than 60 volts, and more preferably is several hundred volts. This means that particularly large amounts of electrical power can be realized for, in particular purely, electrically driving the motor vehicle.

In the scope of the present disclosure, ordinals, also referred to as ordinal numbers, such as for example, “first”, “second” etc., are not necessarily used to specify a number of terms or elements to which the ordinal numbers refer, but rather to be able to clearly make reference to the terms or elements to which the ordinal numbers refer, and to be able to differentiate clearly between the elements or terms to which the ordinal numbers refer.

In the context of the present disclosure, the feature that two components, such as for example the planetary carriers, are connected to each other for conjoint rotation is to be understood as meaning that the components connected to each other for conjoint rotation are arranged coaxially to each other and, in particular when the components are driven, they rotate together or simultaneously about a rotational axis common to the components, with the same angular velocity, in particular relative to the housing of the gearbox, also referred to as gearbox housing. The feature that two components are connected to each other in a torque-transmitting manner means that the components are coupled to each other in such a way that torques can be transmitted between the components, wherein if the components are connected to each other for conjoint rotation, the components are also connected to each other in a torque-transmitting manner. Again, expressed in other words, the term “for conjoint rotation” means that two elements are connected to each other for conjoint rotation when the elements are arranged coaxially to each other and are connected to each other in such a way that they rotate at the same angular velocity in particular about a common rotational axis, such as for example the aforementioned component rotational axis.

The feature that two components are permanently connected to each other in a torque-transmitting manner means that rather than a switching element being provided which can be switched over between a coupled state connecting the components to each other in a torque-transmitting manner and a decoupled state in which no torques can be transmitted between the components via the switching element, instead the components are constantly or always and thus permanently connected to each other in a torque-transmitting manner, i.e. in such a way that a torque can be transmitted between the components, in particular via the switching element. This means, for example, that one of the components can be driven by the respective other component or vice versa. In particular, the feature that two components are permanently connected to each other for conjoint rotation means that rather than a switching element being provided which can be switched over between a coupled state in which the components are connected to each other for conjoint rotation and a decoupled state in which the components are decoupled from each other and can be rotated relative to each other so that no torques be transmitted between the components via the switching element, instead the components are constantly or always connected or coupled to each other, i.e. permanently, for conjoint rotation.

The feature that two components can be connected to each other for conjoint rotation or in a torque-transmitting manner means, in particular, that the components are assigned a switchover element which can be switched over between one coupled state and at least one decoupled state. In the coupled state, the components are connected to each other by means of the switchover element for conjoint rotation or in a torque-transmitting manner. In the decoupled state, the components are decoupled from each other, so that in the decoupled state the components can be rotated relative to each other in particular about the component rotational axis, and in particular so that torques cannot be transmitted between the components via the switchover element.

The terms “axial” and “radial” refer to a cylinder axis, also referred to as a symmetry axis or designed as a symmetry axis, of the cylinder which is designed to be rotationally symmetrical in relation to the cylinder axis. Thus, the term “axial” is understood to mean the axial direction of the cylinder and thus of the actuating piston, coinciding with the cylinder axis, and the term “radial” is understood to mean the radial direction of the cylinder and thus of the actuating piston, running perpendicular to the axial direction of the cylinder. For example, the gearbox has a main rotational axis which, for example, coincides with the first shaft rotational axis and with the second shaft rotational axis. For example, the sun gears, the planetary carriers and the ring gears are gear elements, wherein the respective gear element can be rotated about the main rotational axis relative to the housing in particular when it is not connected to the housing of the gearbox for conjoint rotation. In this case, it can be provided that the axial direction of the cylinder runs parallel to the main rotational axis and thus to the axial direction of the gearbox. The feature that the first electric engine and the second electric engine are arranged axially on different sides of the differential gear is in particular understood to mean that the first electric engine and the second electric engine are arranged on different sides of the differential gear, when viewed in the axial direction of the gearbox and thus along the main rotational axis, so that the second side of the differential gear is facing away from the first side of the gearbox, when viewed in the axial direction of the gearbox and thus along the main rotational axis, and vice versa. In this case, it is conceivable that the axial direction of the gearbox, the radial direction of which runs parallel to the axial direction of the gearbox, runs parallel to the axial direction of the cylinder and thus of the actuating piston or coincides with the axial direction of the cylinder or of the actuating piston.

The respective switching unit and thus the aforementioned switching element is understood to mean a device for connecting two connecting elements for conjoint rotation, wherein the connecting elements can be shafts, for example. Thus, for example, one of the connecting elements is the gearbox shaft, while the other connecting element can be the differential input shaft, for example. It is also conceivable that at least one of the connecting elements is a gear wheel, in particular of the gearbox. The respective switching unit has, for example, a respective first switching half and a respective second switching half. For example, the first switching half is connected, in particular permanently, to one of the connecting elements for conjoint rotation, while the second switching half is connected, in particular permanently, to the other connecting element for conjoint rotation. For example, the switching unit can be a claw switching element having a first claw half and a second claw half, so that, for example, the first switching half is the first claw half and the second switching half is the second claw half. It is also conceivable that the switching unit is a multiple disc shifting element having a first disc pack and a second disc pack, so that the first disc pack is the first switching half and the second disc pack is the second switching half.

Further advantages, features and details of the invention can be seen from the following description of a preferred exemplary embodiment and with reference to the drawing. The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

### BRIEF DESCRIPTION OF THE DRAWING FIGURES

The figures show:

FIG. 1 a schematic longitudinal sectional view of a switching device for a gearbox of a vehicle; and

FIG. 2 a schematic illustration of the gearbox.

In the figures, identical or functionally identical elements are provided with the same reference numerals.

### DETAILED DESCRIPTION OF THE DRAWINGS

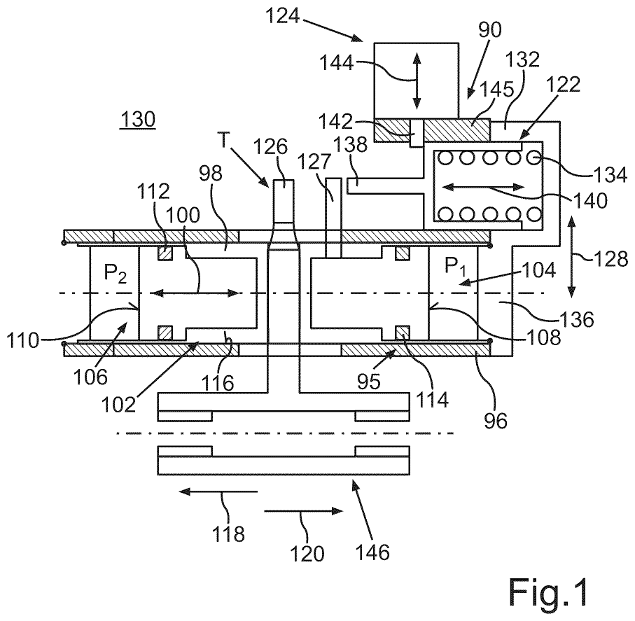

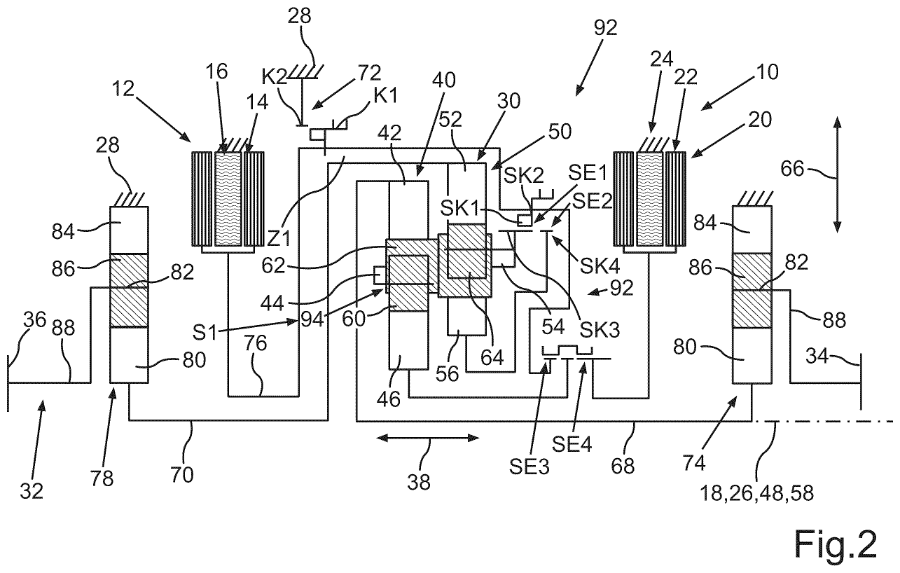

FIG. 1 shows a switching device 90 for a gearbox 92 (FIG. 2) of a motor vehicle, also simply referred to as a vehicle, in a schematic sectional view. It can be seen from FIGS. 1 and 2 that the motor vehicle in its completely produced state has an electric drive system 10, illustrated schematically in FIG. 2, which has the gearbox 92 and this the switching device 90. The electric drive system 10 has a first electric engine 12 which has a first rotor 14 and a first stator 16. For example, the electric engine 12 is designed as an axial flux machine (AFM). The rotor 14 can be driven by means of the stator 16 and thus can be rotated about a first engine rotational axis 18 relative to the stator 16. The electric drive system 10 furthermore comprises a second electric engine 20 which has a second rotor 22 and a second stator 24.

In the exemplary embodiment shown in FIG. 2, the electric engine 20 is designed as an axial flux machine. In particular, the drive system 10 can be or can comprise the gearbox 92. In particular, it is conceivable that the gearbox 92 has the electric engines 12 and 20. The rotor 22 can be driven by means of the stator 24 and thus can be rotated about a second engine rotational axis 26 relative to the stator 24. It can be seen that the electric engines 12 and 20 are arranged coaxially to each other, so that the engine rotational axes 18 and 26 coincide. A housing 28 of the gearbox 92 and thus of the drive system 10, also referred to as gearbox housing, is illustrated particularly schematically in FIG. 1. For example, the respective electric engine 12, 20 is arranged at least partially in the housing 28. The rotors 14 and 22 can be rotated about the respective engine rotational axis 18, 26 relative to the housing 28.

The gearbox 92 and thus the drive system 10 comprise a transmission device 30, also referred to as a coupling gear or designed as a coupling gear, in the planetary construction. As the transmission device 30 is a component part of the gearbox 92, the transmission device 30 is also referred to as a sub-gearbox or partial gearbox. When the coupling gear is referred to above or in the following, unless otherwise stated, this means the transmission device 30. The transmission device 30 is arranged at least partially in the housing 28. For example, the gearbox 92, in particular the drive system 10, is a component part of an axle 32 of the motor vehicle, also referred to as a vehicle axle or drive axle.

The axle 32 has two, in particular exactly two, vehicle wheels 34 and 36 which are arranged on sides of the motor vehicle opposing each other in the vehicle transverse direction of the motor vehicle. The vehicle transverse direction is illustrated by a double arrow 38. The vehicle wheels 34 and 36, also simply referred to as wheels or drive wheels, are ground contact elements by means of which the motor vehicle is or can be supported downwards on ground in the vehicle vertical direction of the motor vehicle. If the motor vehicle drives along the ground while the motor vehicle is supported downwards on the ground by the drive wheels in the vehicle vertical direction, then the drive wheels roll, in particular directly, on the ground. The vehicle wheels 34 and 36 can be driven, in particular purely, electrically via the transmission device 30 by the respective electric engine 12, 20, and so the vehicle wheels 34 and 36 are also referred to as drive wheels.

The transmission device 30 and thus the gearbox 92 have a first planetary gear set 40, which has a first ring gear 42, a first planetary carrier 44 and a first sun gear 46. The ring gear 42, the planetary carrier 44 and the sun gear 46 are gear elements of the first planetary gear set 40, wherein the respective gear element can be rotated about a first planetary gear set rotational axis 48 relative to the housing 28, in particular when it is not connected to the housing 28 for conjoint rotation. The transmission device 30 and thus the gearbox 92 have a second planetary gear set 50, which has a second ring gear 52, a second planetary carrier 54 and a second sun gear 56. The ring gear 52, the planetary carrier 54 and the sun gear 56 are planetary gear set elements of the second planetary gear set, wherein the respective planetary gear set element can be rotated about a second planetary gear set rotational axis 48 relative to the housing 28, in particular when it is not connected to the housing 28 for conjoint rotation. The planetary gear sets 40 and 50 are arranged coaxially to each other, so that the planetary gear set rotational axes 48 and 58 coincide. Furthermore, the planetary gear sets 40 and 50 are arranged coaxially to the electric engines 12 and 20, so that the planetary gear set rotational axes 48 and 58 coincide with the engine rotational axes 18 and 26. Thus, the gearbox 92 has a main rotational axis, for example, which coincides with the planetary gear set rotational axes 48 and 58 and with the engine rotational axes 18 and 26.

First planetary gears 60 and second planetary gears 62 are arranged, i.e., held, rotatably on the first planetary carrier 44, wherein the first planetary gears 60 mesh, in particular permanently, with the first sun gear 46. The second planetary gears 62 mesh, in particular permanently, with the ring gear 42, and in each case one of the first planetary gears 60 meshes, in particular permanently, with a respective one, in particular with exactly one, of the second planetary gears 62. In this case, for example, the respective second planetary gear 62 has a respective first toothing, which meshes, in particular permanently, with the ring gear 42 and with the respective, first planetary gear 60. The respective planetary gear 62 does not mesh, for example, with the sun gear 46. The respective planetary gear 60 does not mesh, for example, with the ring gear 42. The second planetary gears 62 are rotatably held on the second planetary carrier 54, and third planetary gears 64 are rotatably held on the second planetary carrier 54. The second planetary gears 62 mesh, in particular permanently, with the sun gear 56. The third planetary gears 64 mesh, in particular permanently, with the ring gear 52. Furthermore, in each case one of the second planetary gears 62 meshes, in particular permanently, with a respective one, in particular with exactly one, of the respective third planetary gears 64. In this case, for example, the respective second planetary gear 62 has a respective second toothing, in particular provided in addition to the respective first toothing, which meshes with the sun gear 56 and the respective third planetary gear 64. The respective planetary gear 60 does not mesh, for example, with the ring gear 42 and the respective planetary gear 62 does not mesh, for example, with the sun gear 46. The respective planetary gear 62 does not mesh, for example, with the ring gear 52 and the respective planetary gear 64 does not mesh, for example, with the sun gear 56. In particular, the respective second planetary gear 62 is designed as a respective staged planetary gear. The first planetary carrier 44 is connected, in particular permanently, to the second planetary carrier 54 for conjoint rotation.

In the exemplary embodiment shown in FIG. 2, the transmission device 30 is a differential gear of the gearbox 92, also simply referred to as a differential, wherein the differential gear is designed in the planetary construction and thus is designed as a planetary differential. Therefore, the planetary carriers 44 and 54 connected, in particular permanently, to each other for conjoint rotation function as a differential input shaft 94 of the differential gear, wherein the differential input shaft 94 can be rotated about the main rotational axis relative to the housing 28.

With regard to an axial direction of the gearbox 92 and thus of the drive system 10, wherein the axial direction of the gearbox 92 and thus of the drive system 10 coincides with the main rotational axis and thus with the engine rotational axes 18 and 26 and with the planetary gear set rotational axes 48 and 58, the first electric engine 12 is arranged on a first side S1 of the transmission device 30 (differential gear), facing away in the axial direction of the gearbox 92 from the second electric engine 20, and with regard to the axial direction of the electric drive system 10 or the gearbox 92, the second electric engine 20 is arranged on a second side S2 of the transmission device 30 (FIG. 2), facing away in the axial direction of the gearbox 92 from the first electric engine 12 and from the first side S1. When the axial direction is referred to above and in the following, if not otherwise stated, it is understood to mean the axial direction of the gearbox 92, the radial direction of which runs perpendicular to the axial direction of the gearbox 92 and thus of the drive system 10, the radial direction of which coincides with the radial direction of the gearbox 92. The axial direction of the drive system 10 and the gearbox 92 coincides with the respective engine rotational axis 18, 26 and thus with the respective planetary gear set rotational axis 48, 58 and with the main rotational axis. The radial direction of the gearbox 92 and thus of the drive system 10 is illustrated in FIG. 2 by a double arrow 66.

The gearbox 92 and thus the drive system 10 have a first switching unit SE1, also referred to as a first switching element, which is designed to connect a gearbox shaft 76 of the gearbox 92 to the planetary carriers 44 and 54 for conjoint rotation and thus to the differential input shaft 94 for conjoint rotation. In the exemplary embodiment shown in FIG. 2, the gearbox shaft 76 is a rotor shaft, which is connected, in particular permanently, to the first rotor 14 of the first electric engine 12 for conjoint rotation. Thus, the first switching unit SE1 is designed to connect the first rotor 14 to the planetary carriers 44 and 54, in particular via the gearbox shaft 76, for conjoint rotation, i.e. to the differential input shaft 94 for conjoint rotation. Therefore, the transmission device 30 and thus the gearbox 92 and the drive system 10 have a first output drive shaft 68 which is connected, in particular permanently, to the first ring gear 42 for conjoint rotation and which is designed to discharge torques, also referred to as first torques, from the transmission device 30 bypassing the planetary carriers 44 and 54 and thus bypassing the differential input shaft 94 and bypassing the sun gears 46 and 56.

The transmission device 30 and thus the gearbox 92 and the drive system 10 furthermore comprise a second output drive shaft 70 which is connected, in particular permanently, to the second ring gear 52 for conjoint rotation and which is designed to discharge torques, also referred to as second torques, from the transmission device 30 bypassing the planetary carriers 44 and 54 and thus bypassing the differential input shaft 94 and bypassing the sun gears 46 and 56. It can be seen that the vehicle wheel 34 can be driven by the output drive shaft 68 and thus by the transmission device 30 via the output drive shaft 68 and by the respective electric engine 12, 20 via said transmission device. Accordingly, the vehicle wheel 36 can be driven by the output drive shaft 70 and thus by the transmission device 30 via the output drive shaft 70 and by the respective electric engine 12, 20 via said transmission device. For example, the transmission device 30 forms or comprises an in particular central superimposing unit, by means of which a respective first drive torque, which is provided for driving the vehicle wheels 34 and 36 and is or can be supplied by the electric engine 12 via its rotor 14, can be superimposed with a respective second drive torque, which is provided for driving the vehicle wheels 34 and 36 and is or can be supplied by the electric engine 20 via the rotor 22, so that the motor vehicle can be driven particularly efficiently.

The gearbox 92 has a parking lock device 72, also simply referred to as a parking lock, by means of which the motor vehicle can be secured against undesired rolling away, in particular when the motor vehicle is parked at or on an incline. The parking lock (parking lock device 72) has a first parking lock coupling half K1, connected, in particular permanently, to the first rotor 14 for conjoint rotation, and a second parking lock coupling half K2 connected, in particular permanently, to the housing 28 for conjoint rotation. The parking lock can be switched over between an engaged and disengaged state. In its engaged state, the parking lock device 72 is engaged, i.e. activated, and in its disengaged state, the parking lock device 72 is disengaged, i.e. deactivated. The engaged state is also referred to as a parking lock coupled state, and the disengaged state is also referred to as a parking lock decoupled state. The parking lock (parking lock device 72) has, for example, a parking lock switching part which can be moved, in particular translationally and/or relative to the housing 28, and which, for example, can be moved, in particular translationally and/or in rotation and/or relative to the housing 28, between at least one parking lock coupling position, causing the parking lock coupled state, and at least one parking lock decoupling position, causing the parking lock decoupled state. For example, the parking lock switching part is provided in addition to the parking lock coupling halves K1 and K2, or the parking switching part is one of the parking lock coupling halves K1 and K2. Thus, for example, one of the parking lock coupling halves K1 and K2 can be moved, in particular in the axial direction of the gearbox 92 and thus of the drive system 10 and/or translationally and/or rotationally and/or relative to the respective other parking lock coupling half K2, K1 and/or relative to the housing 28, between the at least one parking lock coupling position, causing the parking lock coupled state, and the at least one parking lock decoupling position, causing the parking lock decoupled state. In the engaged state of the parking lock, the parking lock coupling halves K1 and K2 are connected to each other for conjoint rotation, whereby the gearbox shaft 76 and via this the rotor 14 are connected to the housing 28 for conjoint rotation. In the disengaged state, the parking lock device 72 allows relative rotations, occurring in particular about the main rotational axis, i.e. about the engine rotational axis 18, between the parking lock coupling halves K1 and K2 and thus relative rotations, occurring in particular about the main rotational axis or about the engine rotational axis 18, between the gearbox shaft 76 and the housing 28 and thus between the rotor 14 and the housing 28.

The switching unit SE1 has, for example, a first switching element coupling half SK1 and a third switching element coupling half SK3. The switching element coupling half SK1 is connected, in particular permanently, to the gearbox shaft 76 and thus to the rotor 14 for conjoint rotation, and the switching element coupling half SK3 is connected, in particular permanently, to the differential input shaft 94 and thus to the planetary carriers 44 and 54 for conjoint rotation. The first switching unit SE1 can be switched over, for example, between a first coupled state and a first decoupled state. In the first coupled state, the gearbox shaft 76 and via this the rotor 14 is connected to the differential input shaft 94 by means of the first switching unit SE1 for conjoint rotation. For example, the first switching element SE1 has a first switching part, which can be moved, in particular displaced, in particular relative to the housing 28 and/or in the axial direction of the gearbox 92 and thus of the drive system 10 and/or translationally, between at least one first coupling position, causing the first coupled state, and at least one first decoupling position, causing the first decoupled state. The first coupling position is also referred to as a first engaged position, and the first decoupling position is also referred to as a first disengaged position. The first switching part can be provided in addition to the switching element coupling halves SK1 and SK3, or the first switching part is one of the switching element coupling halves SK1 and SK3. Thus, for example, one of the switching element coupling halves SK1 and SK3 can be moved, in particular relative to the housing 28 and/or in the axial direction of the gearbox 92 and/or translationally and/or relative to the respective other switching element coupling half SK3, SK1, between the at least one first coupling position (first engaged position), causing the first coupled state, and the at least one first decoupled position (first disengaged position), causing the first decoupled state. Thus, for example, the one of the switching element coupling halves SK1 and SK3 is the first switching part of the first switching element (first switching unit SE1).

Furthermore, for example, the one of the parking lock coupling halves K1 and K2 is the parking lock switching part of the parking lock (parking lock device 72). More preferably, it can be provided that the parking lock switching part can be moved relative to and thus independently of the first switching part between the parking lock coupling position and the parking lock decoupling position, and more preferably it is provided that the first switching part can be moved relative to and thus independently of the parking lock switching part between the first coupling position and the first decoupling position. Thus, it can be provided that the parking lock switching part can be moved between the parking lock coupling position and the parking lock decoupling position, while, for example, the first switching part remains in the first coupling position or in the first decoupling position, and, for example, the first switching part can be moved between the first coupling position and the first decoupling position, while, for example, the parking lock switching part remains in the parking lock coupling position or in the parking lock decoupling position, i.e. is not moved. Again, expressed in other words, it is preferably provided that the parking lock switching part and the first switching part are decoupled from each other with regard to their movements. Thus, the first switching unit SE1 can be moved, in particular displaced, between the first engaged position and the first disengaged position in particular relative to the housing 28 of the gearbox 92. This is understood to mean that at least one first part of the first switching unit SE1 can be moved, in particular displaced, between the first engaged position and the first disengaged position, wherein, for example, the first part can be the first switching part.

The gearbox 92 and thus the drive system 10 has a second switching unit SE2, which is also referred to as a second switching element. The second switching unit SE2 is designed to connect the gearbox shaft 76 and thus, via the gearbox shaft 76, the first rotor 14 to the second sun gear 56 for conjoint rotation. In this case, for example, the second switching unit SE2 (second switching element) has a second switching element coupling half SK2, which is connected, in particular permanently, to the gearbox shaft 76 for conjoint rotation, and thus via this is connected, in particular permanently, to the first rotor 14 for conjoint rotation. Furthermore, the second switching unit SE2 has a fourth switching element coupling half SK4, which is connected, in particular permanently, to the sun gear 56 for conjoint rotation. In the first coupled state of the first switching unit SE1, the switching element coupling halves SK3 and SK1 are connected to each other for conjoint rotation, and in the first decoupled state of the first switching element (first switching unit SE1), the switching element coupling halves SK1 and SK3 can be rotated relative to each other in particular about the engine rotational axis 18.

The switching unit SE2 can be switched over, for example, between a second coupled state and a second decoupled state. In the second coupled state, the switching element coupling halves SK2 and SK4 are connected to each other for conjoint rotation, whereby in the second coupled state, the gearbox shaft 76 and thus the first rotor 14 are connected to the second sun gear 56 for conjoint rotation by means of the second switching unit SE2. In the second decoupled state, the switching element coupling halves SK2 and SK4 can be rotated relative to each other, in particular about the engine rotational axis 18 or the main rotational axis, so that in the second decoupled state, the gearbox shaft 76 and thus the rotor 14 can be rotated relative to the sun gear 56, in particular about the engine rotational axis 18 or about the main rotational axis. For example, the second switching unit SE2 has a second switching part which can be moved, in particular in the axial direction of the gearbox 92 and thus of the drive system 10 and/or translationally and/or relative to the housing 28, between at least one second coupling position, causing the second coupled state, and at least one second decoupling position, causing the second decoupled state. The second coupling position is also referred to as a second engaged position, and the second decoupling position is also referred to as a second disengaged position.

The second switching part can be provided in addition to the switching element coupling halves SK2 and SK4, or the second switching part is one of the switching element coupling halves SK2 and SK4. Thus, in particular it can be provided that one of the switching element coupling halves SK2 and SK4 can be moved, in particular translationally moved and thus displaced, in particular in the axial direction of the gearbox 92 and thus of the drive system 10 and/or translationally and/or relative to the housing 28 and/or relative to the respective other of the switching element coupling halves SK2 and SK4, between the at least one second coupling position (second engaged position), causing the second coupled state, and the at least one second decoupling position (second disengaged position), causing the second decoupled state, so that, for example, the one of the switching element coupling halves SK2 and SK4 is the second switching part of the second switching element (second switching unit SE2) or is also referred to as a second switching part of the second switching unit SE2. The second switching unit SE2 can thus be moved, in particular displaced, in particular translationally and/or in the axial direction of the gearbox 92 and/or relative to the housing 28, between the second engaged position and the second disengaged position. This is understood to mean that at least one second part of the second switching unit SE2 can be moved, in particular displaced, in particular translationally and/or relative to the housing 28 and/or in the axial direction of the gearbox 92, between the second engaged position and the second disengaged position. In particular the second part is the second switching part. The above and following embodiments for the first part of the first switching unit SE1 or the first switching part can also be transferred easily to the second part of the second switching unit SE2 or the second switching part respectively, and vice versa.

It can be provided that the second switching part is connected to the first switching part for conjoint rotation, and the first switching part is connected fixed to the second switching part in the axial direction of the gearbox 92, for example, so that in particular relative movements occurring in the axial direction of the gearbox 92 between the first switching part and the second switching part are omitted. In particular, the second switching part can be moved with the first switching part, so that in particular the first switching unit SE1 can be moved with the second switching unit SE2 or vice versa. It can be provided that the first switching part is the switching element coupling half SK1 and, for example, the second switching part is the switching element coupling half SK2. In particular, the first switching part and the second switching part or the switching units SE1 and SE2 can be moved with each other and thus simultaneously or together, in particular in the axial direction of the gearbox 92, in such a way that the second switching part is located in the second decoupling position when the first switching part is located in the first coupling position and in such a way that the second switching part is located in the second coupling position when the first switching part is located in the first decoupling position. Thus, the second decoupling position accompanies the first coupling position, and the second coupling position accompanies the first decoupling position. Again, expressed in other words, the first switching unit SE1 is therefore located in the first engaged position, while the second switching unit SE2 is located in the second disengaged position. Furthermore, the first switching unit SE1 is located in the first disengaged position, while the second switching unit SE2 is located in the second engaged position.

The gearbox 92 and thus the drive system 10 further comprise a third switching unit SE3, which is also referred to as a third switching element. The third switching unit SE3 is designed to connect the second rotor 22 to the gearbox shaft 76 for conjoint rotation. The gearbox 92 and thus the drive system further comprise a fourth switching unit SE4, also referred to as a fourth switching element, which is designed to connect the second rotor 22 to the first sun gear 46 for conjoint rotation. For this purpose, for example, the third switching unit SE3 can be switched over between a third coupled state and a third decoupled state. In the third coupled state, the second rotor 22 is connected to the gearbox shaft 76 by means of the third switching unit SE3 for conjoint rotation. In the third decoupled state, the third switching unit SE3 allows relative rotations occurring about the main rotational axis or the engine rotational axis 18, between the second rotor 22 and the gearbox shaft 76. The fourth switching unit SE4 can be switched over, for example, between a fourth coupled state and a fourth decoupled state. In the fourth coupled state, the second rotor 22 is connected to the sun gear 46 by means of the fourth switching unit SE4 for conjoint rotation. In the fourth decoupled state, the fourth switching element (fourth switching unit SE4) allows relative rotations running about the engine rotational axis 26 or about the main rotational axis, between the second rotor 22 and the first sun gear 46.

For example, the electric drive system 10 or the gearbox 92 has different modes, in which the gearbox 92 or the drive system 10 can be operated or in which the gearbox 92 and thus the drive system 10 can be switched. In a first of the modes, the parking lock (parking lock device 72) is engaged, whereby the motor vehicle is secured against undesired rolling away. For this purpose, the parking lock device 72 is located in its engaged state, i.e. in the parking lock coupled state, while the first switching unit SE1 is located in its first coupled state, i.e. in its first engaged position, while, for example, the second switching unit SE2 is located in its second decoupled state, i.e. in its second disengaged position, and while, for example, the third switching unit SE3 is located in its third decoupled state and the switching unit SE4 is located in its fourth decoupled state. Preferably, it is provided that the fourth switching unit SE4 is located in its fourth decoupled state when and preferably whenever the third switching unit SE3 is located in its third coupled state. More preferably, it is provided that the fourth switching unit SE4 is located in its fourth coupled state when and preferably whenever the third switching unit SE3 is located in its third decoupled state.

A second of the modes is, for example, an efficiency mode, in which the parking lock device 72 is located in its parking lock decoupled state, while the switching unit SE1 is located in its first coupled state, i.e., in its first engaged position, the second switching unit SE2 is located in its second decoupled state, i.e., in its second disengaged position, the third switching unit SE3 is located in its third decoupled state and the fourth switching unit SE4 is located in its fourth coupled state.

A third of the modes is, for example, a superimposing mode, in which the parking lock device 72 is located in its parking lock decoupled state, while the first switching unit SE1 is located in its first coupled state, i.e., in its first engaged position, the second switching unit SE2 is located in its second decoupled state, i.e. in its second disengaged position, the third switching unit SE3 is located in its third decoupled state and the fourth switching unit SE4 is located in its fourth coupled state.

A fourth of the modes is, for example, an efficiency-support mode, also referred to as an efficiency-boost mode, in which the parking lock device 72 is located in its parking lock decoupled state, while the first switching unit SE1 is located in its first coupled state, i.e., in its first engaged position, the second switching unit SE2 is located in its second decoupled state, i.e., in its second disengaged position, the third switching unit SE3 is located in its third coupled state and the fourth switching unit SE4 is located in its fourth decoupled state. A fifth of the modes is, for example, a torque displacement and totalizer mode, in which the parking lock device 72 is located in its parking lock decoupled state, while the first switching unit SE1 is located in its first decoupled state, i.e., in its first disengaged position, the second switching unit SE2 is located in its second engaged position, i.e. in its second coupled state, the third switching unit SE3 is located in its third decoupled state and the fourth switching unit SE4 is located in its fourth coupled state.

It can be seen that the ring gears 42 and 52 are or represent drives of the transmission device 30, as the torques can be discharged from the transmission device 30 via the ring gears 42 and 52. In other words, the ring gears 42 and 52 function as differential output shafts of the differential gear. Furthermore, the electric engines 12 and 20 are arranged on both sides of the transmission device 30 in the axial direction of the gearbox 92. In particular, this means that the planetary carriers 44 and 54, for example, and shafts, also referred to as carrier shafts, connected to the planetary carriers 44 and 54 for conjoint rotation, to which the parking lock device 72 and the parking lock coupling half K1 can be advantageously connected, are difficult to access or inaccessible, as therefore they are in particular hidden or covered outwardly by the output drive shafts 68 and 70 and by any provided drive shafts and associated switching elements.

Despite these conditions, it is possible with the gearbox 92 and thus with the drive system 10 that the one parking lock device 72 simultaneously acts on both output drive shafts 68 and 70 and thus on both vehicle wheels 34 and 36, in particular in such a way that when the parking lock device 72 is engaged, the output drive shafts 68 and 70 and thus the vehicle wheels 34 and 36 are secured against undesired rotation, in particular relative to the housing 28. For this purpose, the parking lock device 72 is engaged, and the first switching unit SE1 is simultaneously located in its first engaged position. Therefore, the motor vehicle can advantageously be secured against undesired rolling away in particular when it is parked at or on an incline, and it can be avoided that an individual, specially provided parking lock needs to be used for each output drive shaft 68, 70. Thus, the number of parts and the costs and the weight can be kept particularly low.

In order to be able to achieve a particularly advantageous switching or switchability of the gearbox 92, the switching device 90 has a double-acting piston-cylinder unit 95, which is also referred to as an actuating unit. The actuating unit has a cylinder 96 and an actuating piston 98 displaceably arranged in the cylinder 96. The actuating piston 98 can be translationally moved and thus displaced along its axial direction relative to the cylinder 96. In other words, the actuating piston 98 can be displaced relative to the cylinder 96 along a movement direction, illustrated in FIG. 1 by a double arrow 100, which coincides with the axial direction of the actuating piston 98, and specifically at least between a first actuating position, a second actuating position and at least one deactivation position, which lies, for example, along the movement direction between the first actuating position and the second actuating position.

It can be seen that the cylinder 96 is a housing designed as a fixed body, which delimits an in particular cylindrical working space 102. The actuating piston 98 is arranged so as to be displaceable in the working space 102, whereby the actuating piston 98 divides the working space 102 into a first working chamber 104 and into a second working chamber 106. The first working chamber 104 is partially and directly delimited by a first actuating surface 108 of the actuating piston 98, and the second working chamber 106 is partially and directly delimited by a second actuating surface 110 of the actuating piston 98. It can be seen that the actuating surface 108 is facing away from the actuating surface 110 in the axial direction of the actuating piston 98 and vice versa. For example, the axial direction of the actuating piston 98 runs parallel to the axial direction of the gearbox 92. Sealing elements 112 and 114, designed as rubber for example, by means of which the actuating piston 98 is sealed against the cylinder 96, in particular against an inner circumferential lateral surface 116 of the cylinder 96, are held on the actuating piston 98 such that they can be moved with the actuating piston 98. Therefore, for example, the working space 102 is in particular directly delimited by the inner circumferential lateral surface 116 of the cylinder 96. If, for example, an actuating fluid, preferably in the form of a liquid and thus a hydraulic liquid, is introduced into the working chamber 104, for example, the actuating piston 98 is loaded, in particular directly, with the actuating fluid introduced into the working chamber 104 via its actuating surface 108.

For example, the actuating fluid in the working chamber 104 has a first pressure P1 which acts on the actuating surface 108 and thus on the actuating piston 98. This means that, for example, the piston 98 can be displaced relative to the cylinder 96 in a first direction, illustrated by an arrow 118, whereby for example, the actuating piston 98 can be displaced from the second actuating position into the deactivation position and from the deactivation position into the first actuating position. If, for example, the actuating fluid is introduced into the working chamber 106, this means that, for example, the actuating piston 98 is loaded, in particular directly, with the actuating fluid introduced into the working chamber 106 via the actuating surface 110. This means that, for example, a pressure P2 of the actuating fluid introduced into the working chamber 106 acts on the actuating piston 98 via the actuating surface 110, whereby, for example, the actuating piston 98 can be displaced relative to the cylinder 96 in a second direction, opposing the first direction and illustrated by an arrow 120. This means that, for example, the actuating piston 98 can be displaced from the first actuating position into the deactivation position and from the deactivation position into the second actuating position. Due to displacement of the actuating piston 98, occurring relative to the cylinder 96, into the first actuating position, the first switching unit SE1, for example, can be moved, in particular displaced, into its first engaged position. Due to displacement of the actuating piston 98, occurring relative to the cylinder 96, into the second actuating position, the first switching unit SE1, for example, can be moved, in particular displaced, into its first disengaged position. Due to the displacement of the actuating piston 98, occurring relative to the cylinder 96, into the deactivation position, the first switching unit SE1, for example, and thus, for example, also the second switching unit SE2 can be moved, in particular displaced, into a respective neutral position. For example, the switching unit SE1 is disengaged in its neutral position, for example, the switching unit SE2 is disengaged in its neutral position, whereby, for example, the switching units SE1 and SE2 are simultaneously located in their disengaged positions, i.e. in their decoupled states. Overall, it can be seen that both the first switching unit SE1 as well as the second switching unit SE2 can be actuated by means of the piston-cylinder unit 95 in such a way that due to the displacement of the actuating piston 98 into the first actuating position, the first switching unit SE1 can be moved into the first engaged position and the switching unit SE2 can be moved into the second disengaged position, and that due to the displacement of the actuating piston 98 into the second actuating position, the first switching unit SE1 can be moved into the first disengaged position and the second switching unit SE2 can be moved into the second engaged position.

The switching device 90 further comprises a spring device 122, by means of which in the present case displacement of the actuating piston 98 into the first actuating position and therefore in particular from the deactivation position and/or from the second actuating position can be caused. In other words, in the present case, the displacement of the actuating piston 98, caused by means of the spring device 122, is a displacement of the actuating piston 98 into the first actuating position, in particular originating from the second actuating position and/or originating from the deactivation position of the actuating piston 98. Furthermore, the switching device 90 comprises a locking device 124, by means of which the spring device 122 can be blocked to prevent the displacement of the actuating piston 98 that can be caused by means of the spring device 122.

The switching device 90 has a carrier 126 that is connected to the actuating piston 98 and thus can be displaced with the actuating piston 98 along the movement direction relative to the cylinder 96, which carrier protrudes from the cylinder 96 and thus projects into surroundings 130 of the cylinder 96 in the radial direction of the actuating piston 98, the radial direction of which runs perpendicular to the axial direction of the actuating piston 98 and thus perpendicular to the movement direction (double arrow 100) and is illustrated in FIG. 1 by a double arrow 128, so that at least one part T of the carrier 126 is arranged outside the cylinder 96 and in the surroundings 130 of the cylinder 96. The displacement of the actuating piston 98 into the first actuating position by means of the spring device 122 can be caused via the carrier 126, whereby the first switching unit SE1 can be moved into its first engaged position.

It can be seen that the spring device 122 is arranged outside and therefore radially outside of the cylinder 96. The spring device 122 has a spring cylinder 132, which is a further housing designed as a fixed body. Furthermore, the spring device 122 has a spring element 134, which in the present case is designed as a fixed body and thus as a mechanical spring. In the exemplary embodiment shown in FIG. 1, the spring element 134 is designed as a spiral spring, for example. It can be seen that the spring element 134 is arranged at least partially inside the spring cylinder 132. The spring cylinder 132 is designed in one piece, i.e. integrally, with a cover 136 of the piston-cylinder unit 95, wherein the working chamber 104 is partially and directly delimited by the cover 136, in particular in the movement direction of the actuating piston 98.

The spring device 122 has a further piston 138, referred to as a further actuating piston, which can be displaced along a second movement direction, illustrated by a double arrow 140, relative to the spring cylinder 132 and thus relative to the cover 136 and relative to the cylinder 96. The second movement direction of the piston 138, illustrated by the double arrow 140, runs parallel to the first movement direction of the piston 98, illustrated by the arrow 100. Thus, the piston 138 can also be displaced in the first direction and in the second direction relative to the cylinder 96 and relative to the spring cylinder 132. The piston 138 is arranged at least partially in the spring cylinder 132. The spring device 122 has, for example, a third cylinder 145, in which in each case the piston 138 and/or the spring element 134 is at least partially arranged. The cylinder 145 is a further housing, designed as a fixed body, wherein, for example, the cylinder 145 can be designed integrally with the cylinder 96. Thus, for example, the cylinder 145 and the spring cylinder 132 form a device housing of the spring device 122, wherein the spring element 134 and the piston 138 are each arranged at least partially in the device housing. Therefore, the piston 138 can be displaced in a second movement direction relative to the device housing.

Due to the displacement of the actuating piston 98 into the second actuating position, occurring relative to the cylinder 96, the piston 138 can be displaced in the second direction relative to the device housing, whereby the spring element 134 is to be tensioned, i.e. is tensioned. Thus, for example, the spring element 134 provides a spring force at least in the second actuating position of the actuating piston 98.

FIG. 1 shows the actuating piston 98 and the carrier 126 connected axially fixed to the actuating piston 98 in the deactivation position. In FIG. 1, a carrier position 127 is represented in the form of a rectangle symbol, which indicates the position of the carrier 126 in the second actuating position. Thus, it is symbolically shown that the carrier 126 and, without this being explicitly shown in FIG. 1, accordingly also the actuating piston 98 are displaced to the right in the second actuating position. Due to the carrier position 127, it is also clear that the carrier 126 displaces the piston 138 so far to the right that the piston 138 can be locked by the locking device 124.

The piston 138 can be displaced relative to the locking housing and relative to the cylinder 96 into the first direction by means of the spring force when the locking device 124 releases the displacement of the actuating piston 98 into the first actuating position that can be caused by means of the spring device 122. In this case, the piston 138 acts on the carrier 126 in such a way that the piston 138 displaces the carrier 126 and via the carrier 126 the actuating piston 98 in the first direction relative to the cylinder 96, and in particular into the first actuating position. In other words, the piston 138 carries the actuating piston 98 via the carrier 126, which in this case is displaced in the first direction relative to the cylinder 96 and in particular into the first actuating position.

In particular, due to the displacement of the actuating piston 98 into the second actuating position, the piston 138 can be displaced in the second direction relative to the device housing and therefore can be displaced into an initial position. In particular, the piston 138 and thus the spring device 122 can interact with the part T, i.e. can displace the carrier 126 via the part T and thus via the carrier 126 and the actuating piston 98 relative to the cylinder 96 in the first direction.

The locking device 124 has a locking element 142, which in the present case can be moved, in particular translationally moved, along a movement direction, illustrated by a double arrow 144, relative to the device housing between at least one locking position shown in FIG. 1 and at least one released position. In the present case, for example, the movement direction illustrated by the double arrow 144 runs perpendicular to the second movement direction of the piston 138, illustrated by the double arrow 140, and perpendicular to the movement direction of the actuating piston 98, illustrated by the double arrow 100. If the piston 138 is located in the initial position and if the locking element 142 is located in the locking position, in the initial position the piston 138 is held against the spring force provided by the spring element 134 by means of the locking element 142, whereby the displacement of the actuating piston 98 into the first actuating position that can be caused by means of the spring device 122 is blocked, i.e. omitted. Due to the movement of the locking element 142 from the locking position into the released position, the locking device 124 releases the piston 138 for displacement that can be caused by means of the spring force of the spring element 134, occurring relative to the locking housing and relative to the cylinder 96 and occurring in the first direction, whereby the actuating piston 98 can be displaced relative to the cylinder 96 into the first actuating position by means of the piston 138 via the carrier 126.

For example, the locking device 124 comprises an actuator, that can be operated in particular electrically, by means of which, for example, the locking element 142 can be moved from the locking position into the released position and/or from the released position into the locking position using electrical energy with which the actuator is supplied. In particular, for example, the actuator can move the locking element 142 from the locking position into the released position using electrical energy with which the actuator is supplied. This means that, for example, a further spring assigned to the locking element 142 is tensioned, whereby the further spring provides at least one second spring force in the released position of the locking element 142, by means of which, for example, the locking element 142 can be moved from the released position into the locking position and, for example, can be held in the locking position. More particularly, the actuator is designed as a solenoid.

The switching device 90 has a shift fork 146, which is connected to the actuating piston 98 and therefore can be displaced with the actuating piston 98 relative to the cylinder 96, in particular into the first actuating position or the second actuating position and the deactivation position. Due to the displacement of the actuating piston 98 into the first actuating position, the shift fork 146 is displaced in the first direction relative to the cylinder 96, whereby the first switching unit SE1 can be moved, in particular displaced, into the first activation position via the shift fork 146. Due to the displacement of the actuating piston 98 into the second actuating position, the shift fork 146 can be displaced in the second direction relative to the cylinder 96, whereby the second switching unit SE2 can be moved, in particular displaced, into the second engaged position. Due to the displacement of the actuating piston 98 into the deactivation position, the shift fork 146 can be displaced together with the actuating piston 98 into the deactivation position thereof, whereby both the switching unit SE1 as well as the switching unit SE2 can be moved, in particular displaced, into their neutral positions.

Overall, it can be seen that the spring device 122 is an additional actuator, by means of which the actuating piston 98 can be displaced, in particular mechanically, into the first actuating position when, for example, hydraulic displacement of the actuating piston 98 into the first actuating position is not possible. In particular when the actuator is designed as a solenoid, the locking element 142 can be electromagnetically moved from the locking position into the released position, whereby the locking device 124 can be unlocked electromagnetically.

Furthermore, it can be seen from FIG. 2 that the gearbox 92 has a first transmission stage 74 which, with regard to a first torque flow along which or via which the respective first torque can be transmitted from the first output drive shaft 68 to the first vehicle wheel 34, is arranged downstream of the first output drive shaft 68 and downstream of the transmission device 30 and upstream of the vehicle wheel 34 in the first torque flow. Accordingly, the gearbox 92 has a second transmission stage 78 which, with regard to a second torque flow via which or along which the respective second torque can be transmitted from the output drive shaft 70 to the second vehicle wheel 36, is arranged downstream of the second output drive shaft 70 and downstream of the transmission device 30 and upstream of the second vehicle wheel 36 in the second torque flow. For example, the respective transmission stage 74, 78 is designed as a respective, third planetary gear set, which has a respective, third sun gear 80, a respective, third planetary carrier 82 and a respective, third ring gear 84. Respective, further planetary gears 86 are rotatably arranged, i.e. held, on the respective planetary carrier 82, wherein the respective planetary gear 86 meshes simultaneously with the respective sun gear 80 and the respective ring gear 84 of the respective transmission stage 74, 78. In the present case, the first output drive shaft 68 is connected, in particular permanently, to the sun gear 80 of the transmission stage 74 for conjoint rotation, and the second output drive shaft 70 is connected, in particular permanently, to the sun gear 80 of the transmission stage 78 for conjoint rotation. The respective ring gear 84 is connected, in particular permanently, to the housing 28 for conjoint rotation. The respective planetary carrier 82 is connected, in particular permanently, to a respective further shaft 88 for conjoint rotation, by which the respective vehicle wheel 34, 36 can be driven. In particular, the respective shaft 88 is connected permanently in a torque-transmitting manner, in particular permanently for conjoint rotation, to the respective vehicle wheel 34, 36.

### LIST OF REFERENCE NUMERALS

10 electric drive system
12 first electric engine
14 first rotor
16 first stator
18 first engine rotational axis
20 second electric engine
22 second rotor
24 second stator
26 second engine rotational axis
28 housing
30 transmission device
32 axis
34 vehicle wheel
36 vehicle wheel
38 double arrow
40 first planetary gear set
42 first ring gear
44 first planetary carrier
46 first sun gear
48 first planetary gear set rotational axis
50 second planetary gear set
52 second ring gear
54 second planetary carrier
56 second sun gear
58 second planetary gear set rotational axis
60 first planetary gear
62 second planetary gear
64 third planetary gear
66 double arrow
68 first output drive shaft
70 second output drive shaft
72 parking lock device
74 first transmission stage
76 gearbox shaft
78 second transmission stage
80 third sun gear
82 third planetary carrier
84 third ring gear
86 further planetary gear
88 further shaft
90 switching device
92 gearbox
94 differential input shaft
95 piston-cylinder unit
96 cylinder
98 piston
100 double arrow
102 working space
104 first working chamber
106 second working chamber
108 first actuating surface
110 second actuating surface
112 sealing element
114 sealing element
116 inner circumferential lateral surface
118 arrow
120 arrow
122 spring device
124 locking device
126 carrier
127 carrier position
128 double arrow
130 surroundings
132 spring cylinder
134 spring element
136 cover
138 piston
140 double arrow
142 locking element
144 double arrow
145 cylinder
146 shift fork
K1 first parking lock coupling half
K2 second parking lock coupling half
P1 pressure
P2 pressure
SE1 first switching unit
SE2 second switching unit
SE3 third switching unit
SE4 fourth switching unit
SK1 first switching element coupling half
SK2 second switching element coupling half
SK3 third switching element coupling half
SK4 fourth switching element coupling half
S1 first side
S2 second side
T part

1-12. (canceled)

13. A switching device for a gearbox of a motor vehicle, the switching device comprising:
a double-acting piston-cylinder unit configured to actuate a first switching unit and a second switching unit, wherein the double-acting piston-cylinder unit comprises
a cylinder;
an actuating piston displaceably arranged in the cylinder;
a spring device configured to cause displacement of the actuating piston; and
a locking device configured to block the spring device to suppress displacement of the actuating piston that can be caused by the spring device; and
a carrier connected to the actuating piston of the double-acting piston-cylinder unit, protruding from the cylinder in a radial direction of the actuating piston and configured to allow the displacement of the actuating piston caused by the spring device so that the first switching unit is moveable into an engaged position of the first switching unit.

14. The switching device of claim 13, wherein the spring device is arranged radially outside the cylinder.

15. The switching device of claim 13, wherein the spring device has a spring cylinder and a spring element arranged at least partially inside the spring cylinder and configured to cause the displacement of the actuating piston.

16. The switching device of claim 15, wherein the spring cylinder is a single piece with a cover of the piston-cylinder unit.

17. The switching device of claim 13, further comprising:
a shift fork connected to the actuating piston.

18. The switching device of claim 17, wherein the shift fork is displaceable by the displacement of the actuating piston caused by the spring device via the carrier so that the first switching unit is moveable into an insertion position via the shift fork.

19. A gearbox for a motor vehicle, the gearbox comprising:
a differential gear comprising
a differential input shaft;
a gearbox shaft;
a parking lock device; and
a switching device comprising
a double-acting piston-cylinder unit configured to actuate a first switching unit and a second switching unit, wherein the double-acting piston-cylinder unit comprises
a cylinder;
an actuating piston displaceably arranged in the cylinder;
a spring device configured to cause displacement of the actuating piston; and
a locking device configured to block the spring device to suppress displacement of the actuating piston that can be caused by the spring device; and
a carrier connected to the actuating piston of the double-acting piston-cylinder unit, protruding from the cylinder in a radial direction of the actuating piston and configured to allow the displacement of the actuating piston caused by the spring device so that the first switching unit is moveable into an engaged position of the first switching unit.

20. The gearbox of claim 19, wherein the parking lock device is configured to connect the gearbox shaft to a housing of the gearbox to conjointly rotate, wherein the first switching unit is configured to connect the gearbox shaft to the differential input shaft to conjointly rotate.

21. The gearbox of claim 19, wherein the gearbox shaft is connected to a first rotor of a first electric engine to conjointly rotate.

22. The gearbox of claim 21, further comprising:
a third switching unit of the gearbox configured to connect the gearbox shaft to a second rotor of a second electric engine to conjointly rotate, and wherein the first electric engine and the second electric engine are arranged axially on different sides of the differential gear.

23. The gearbox of claim 19, wherein the gearbox comprises:
a first planetary gear set having a first sun gear, a first planetary carrier and a first ring gear; and
a second planetary gear set having a second sun gear, a second planetary carrier and a second ring gear,
wherein the first planetary carrier and the second planetary carrier are connected to each other to conjointly rotate and are configured as the differential input shaft,
wherein the first ring gear and the second ring gear are configured as differential output shafts, and
wherein the second switching unit is configured to connect the gearbox shaft to the second sun gear to conjointly rotate.

24. A motor vehicle comprising:
at least one electric engine; and
a gearbox coupled to the at least one electric engine, the gearbox comprising:
a differential gear comprising
a differential input shaft;
a gearbox shaft;
a parking lock device; and
a switching device comprising
a double-acting piston-cylinder unit configured to actuate a first switching unit and a second switching unit, wherein the double-acting piston-cylinder unit comprises
a cylinder;
an actuating piston displaceably arranged in the cylinder;
a spring device configured to cause displacement of the actuating piston; and
a locking device configured to block the spring device to suppress displacement of the actuating piston that can be caused by the spring device; and
a carrier connected to the actuating piston of the double-acting piston-cylinder unit, protruding from the cylinder in a radial direction of the actuating piston and configured to allow the displacement of the actuating piston caused by the spring device so that the first switching unit is moveable into an engaged position of the first switching unit.
